(19) United States
(12) Patent Application Publication
(10) Pub. No.: US 2026/0208686 A1
(43) Pub. Date: Jul. 23, 2026

(54) AIRBAG DEVICE

(71) Applicant: AUTOLIV DEVELOPMENT AB, Vargarda (SE)

(72) Inventors: Kazuhiro ABE, Kanagawa (JP); Kazuki MORITA, Kanagawa (JP); Noe TOKUNAGA, Kanagawa (JP); Toshihide NEMOTO, Kanagawa (JP); Daisuke FUJITA, Kanagawa (JP); Masanori KANEKO, Kanagawa (JP); Murakami SHO, Kanagawa (JP); Yuka MIURA, Kanagawa (JP); Takuma SHIMADA, Kanagawa (JP); Keitoku MIYAGI, Kanagawa (JP); Jeddu NIRANJAN, Kanagawa (JP)

(21) Appl. No.: 19/139,035

(22) PCT Filed: Nov. 19, 2023
(86) PCT No.: PCT/JP2023/041554

§ 371 Date: Jun. 13, 2025

(30) Foreign Application Priority Data
Dec. 14, 2022 (JP) 2022-199401

(51) Int. Cl. B60R 21/233; B60R 21/00; B60R 21/206; B60R 21/213; B60R 21/231; B60R 21/2334; B60R 21/239

(52) U.S. Cl. CPC B60R 21/233; B60R 21/206; B60R 21/213; B60R 21/2334; B60R 21/239; B60R 2021/0032; B60R 2021/0051; B60R 2021/23107

(57) ABSTRACT

An airbag device for protecting an occupant in a cabin of a vehicle, the airbag device including: a front airbag that expands and deploys in front of an occupant seated in a seat; and an inflator that supplies expansion gas to the front airbag. Furthermore, the front airbag includes: a first chamber that deploys downward from a roof portion of the vehicle; and a second chamber that deploys in front of the first chamber.

### TECHNICAL FIELD

The present invention relates to an airbag device for protecting an occupant riding in a vehicle. In particular, the present invention relates to an improvement to an airbag device including an airbag that deploys from a roof portion of a vehicle cabin.

### BACKGROUND ART

The provision of a vehicle with one or a plurality of kinds of airbags in order to protect an occupant in the event of a vehicle accident is well known. There are various forms of airbags, including, for example: a so-called driver airbag that expands from a vicinity of a center of a steering wheel of an automobile in order to protect a driver; a front passenger airbag that expands from the instrument panel in order to protect an occupant in a front passenger seat; a curtain airbag that deploys in a downward direction on the inner side of a window of the automobile in order to protect the occupant in the event of an impact in the vehicle lateral direction or an overturn or rollover accident; a side airbag that deploys from a side part of a seat in order to protect the occupant in the event of an impact in the vehicle lateral direction; and the like.

In recent years, as autonomous driving technology (level) for vehicles has advanced, there has been an increase in the design freedom of vehicle cabins. In such situations, airbags that deploy from a steering wheel or instrument panel may not adequately protect an occupant. Therefore, as disclosed in Patent Documents 1 and 2, methods have been proposed in which an airbag deploys from a roof portion inside a vehicle cabin.

However, in the inventions disclosed in Patent Documents 1 and 2, an airbag is deployed toward a windshield side, and thus depending on the physique and seating posture of the occupant, it may not be possible to adequately restrain the occupant. For example, if a seat is set in a forwardmost position, there is a risk that the occupant's head will strike an instrument panel before an airbag reaches the occupant. Furthermore, in the case of a vehicle provided with a large display monitor on an instrument panel, there is a risk that a deployed airbag may interfere with the monitor.

### RELATED ART DOCUMENTS

### Patent Documents

Patent Document 1: European Patent No. 2686206

Patent Document 2: U.S. Pat. No. 6,460,878

### SUMMARY OF THE INVENTION

### Problem to be Solved by the Invention

In view of the foregoing situations, an object of the present invention is to provide an airbag device including an airbag that deploys from a roof portion of a vehicle cabin and capable of adequately protecting an occupant.

### Means for Solving the Problem

In order to solve the aforementioned problem, the present invention is an airbag device for protecting an occupant in a cabin of a vehicle, the airbag device including: a front airbag that expands and deploys in front of an occupant seated in a seat; and an inflator that supplies expansion gas to the front airbag. Furthermore, the front airbag includes: a first chamber that deploys downward from a roof portion of the vehicle; and a second chamber that deploys in front of the first chamber.

Herein, “in front of an occupant seated in a seat” can be considered to be, for example, an area between the occupant's head and an instrument panel. Furthermore, “downward” does not necessarily mean a completely vertical direction, but also includes a slight incline or curve.

Furthermore, the phrase “the front airbag deploys from the roof portion” includes, for example, a configuration in which a folded airbag is stowed on the inner side of a roof lining and, when the airbag device is activated, breaks part of the roof lining and deploys into the vehicle cabin. However, this does not exclude a configuration in which the folded airbag is installed on the outer side (vehicle cabin side) of the roof lining.

As described above, the first chamber deploys downward from the roof portion of the vehicle, and thus the front airbag can be deployed quickly on the front surface of the occupant. Furthermore, the second chamber deploys in front of the first chamber such that the deployment behavior and deployment shape of the entire front airbag can be controlled by adjusting the arrangement, connection method, capacity ratio, and the like of the first chamber and second chamber.

The second chamber can be connected to the front of the first chamber. Furthermore, a communication port through which gas flows can be provided at a connecting portion between the first chamber and the second chamber, and the expansion gas can flow from the first chamber into the second chamber through the communication port.

As described above, by using a configuration in which the expansion gas flows from the first chamber to the second chamber, the first chamber can be quickly deployed first, making it possible to quickly restrain the forward movement of the occupant.

The communication port can be provided with a check valve, and the expansion gas that has flowed into the second chamber can be prevented from flowing back into the first chamber.

The check valve can close when the internal pressure of the second chamber reaches or exceeds a prescribed pressure.

For example, when an occupant with a large physique enters the first chamber, the internal pressure of the first chamber increases, the check valve opens, and the expansion gas flows from the first chamber to the second chamber. Thereby, the stroke (impact absorption range) of the entire front airbag can be increased in a front-back direction, thereby enabling the occupant to be adequately protected.

On the other hand, when an occupant having a small physique enters the first chamber, the internal pressure in the first chamber does not increase very much. Thus, the check valve does not open or opens only slightly, and only a small amount or no expansion gas flows from the first chamber to the second chamber. Thereby, the front airbag as a whole can expand less, providing softer protection for the occupant.

The second chamber can be connected to the first chamber below the center in an up-down direction.

The first chamber can deploy behind an instrument panel.

Herein, the “instrument panel” is in front of a front seat of the vehicle, is a portion positioned on a lower side of a windshield, is generally formed of resin, and also may be called a dashboard.

The second chamber can expand and deploy between the first chamber and the instrument panel.

The first chamber preferably has a larger capacity than the second chamber.

The airbag device can further include a knee airbag that deploys from a lower part of an instrument panel toward a lower extremity of an occupant, and a lower end of one of the first chamber and the second chamber can be in contact with an upper end of the knee airbag.

As described above, the lower end of at least one of the expanded and deployed first chamber and second chamber comes into contact with the upper end of the knee airbag, such that a lower side of the front airbag is supported by the knee airbag, thereby providing the advantage of stabilizing the deployment behavior of the front airbag.

A first exhaust port for exhausting the expansion gas can be formed in the first chamber.

A configuration is possible in which an exhaust port for exhausting the expansion gas is not formed in the second chamber.

A slit-shaped or slot-shaped vent opening extending in the up-down direction can be formed in the first chamber, and the vent opening can open widely when the lower end of the first chamber is subjected to pressure by some obstacle.

For example, in situations where there is fragile luggage (obstacle) placed on a seat, where a small child is lying down on the seat, or where a dog, cat, or other pet is sitting on the seat, it is possible to avoid damage to these obstacles due to excess pressure.

Note that the “up-down direction” does not necessarily mean a completely vertical direction, but also includes a situation in which the direction is inclined to some degree. In other words, the vent opening may open widely due to an obstacle on the seat.

The first chamber can be deployed downward from a vicinity of a boundary between a roof and the windshield of the vehicle.

For example, in a typical vehicle, the first chamber can be deployed from a portion corresponding to a back side of a sun visor.

The second chamber may expand and deploy between the first chamber and the windshield. This allows the second chamber to utilize a reaction force from the windshield when the front airbag is deployed, stabilizing the deployment behavior of the front airbag.

Note that in the specification, claims, and drawings of the present application, “front” refers to the front (in a traveling direction) of a vehicle, “back” refers to the rear (opposite side from the traveling direction) of the vehicle, “right” refers to the right side in the traveling direction, “left” refers to the left side in the traveling direction, and “vehicle width direction” refers to the left-right direction.

### BRIEF DESCRIPTION OF THE DRAWINGS

FIG. 1 is a side surface view depicting the inside of a vehicle provided with an airbag device according to the present invention;

FIGS. 2(A) and 2(B) are side surface views depicting deployed states of front airbags according to Embodiment 1 of the present invention;

FIG. 3(A) is a front surface view depicting a structure of the front airbags according to Embodiment 1 of the present invention; FIG. 3(B) is a cross-sectional view along B-B in FIG. 3(A);

FIGS. 4(A) and 4(B) are cross-sectional views depicting a first deployed state (A) and a second deployed state (B), respectively, of the front airbags according to Embodiment 1 of the present invention;

FIGS. 5(A) and 5(B) are side surface views depicting deployed states of an airbag device according to Embodiment 1 of the present invention;

FIGS. 6(A) and 6(B) are side surface views depicting deployed states of the airbag device according to Embodiment 1 of the present invention; and

FIGS. 7(A) and 7(B) are side surface views depicting deployed states of an airbag device according to Embodiment 2 of the present invention.

### DESCRIPTION OF THE PREFERRED EMBODIMENTS

An airbag device for a front passenger seat according to embodiments of the present invention is described in detail below on the basis of the accompanying drawings. Note that in the present embodiment, while occupants P0, P1 are based on experimental dummies, it goes without saying that the same functions will be achieved with an actual occupant (human). In the present invention, the term “occupant” is assumed to be an occupant conforming to a frontal collision test dummy (Hybrid III AM50; human body dummy for frontal collision test set forth in specification [49CFR Part 572 Subpart E and O] of NHTSA [National Highway Traffic Safety Administration]). Occupant P0 refers to an occupant having a physique equivalent to that of an average male in the United States, corresponding to AM50, and having the following approximate size: height of 175 cm, seated height of 88 cm, and body weight of approximately 78 kg. The occupant P1 corresponds to the AF05 standard and has the physique of a small American woman (height: 145 cm, seated: height 79 cm, body weight: approximately 49 kg).

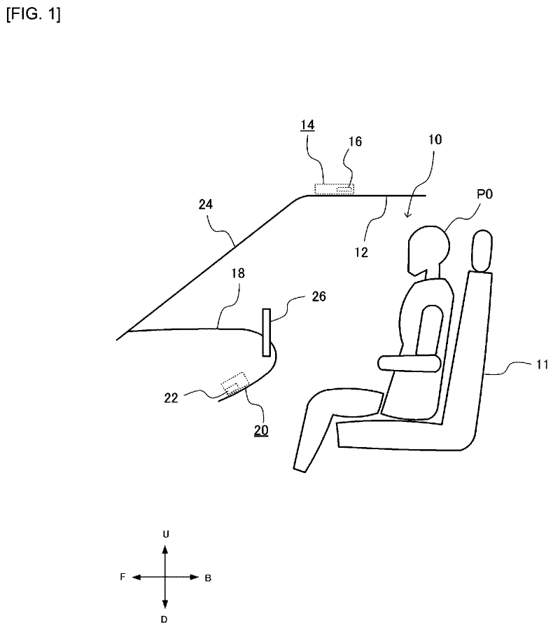

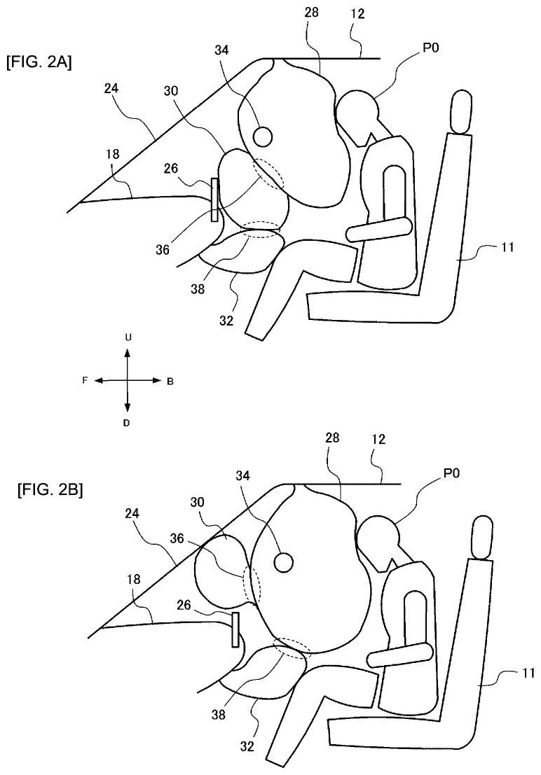

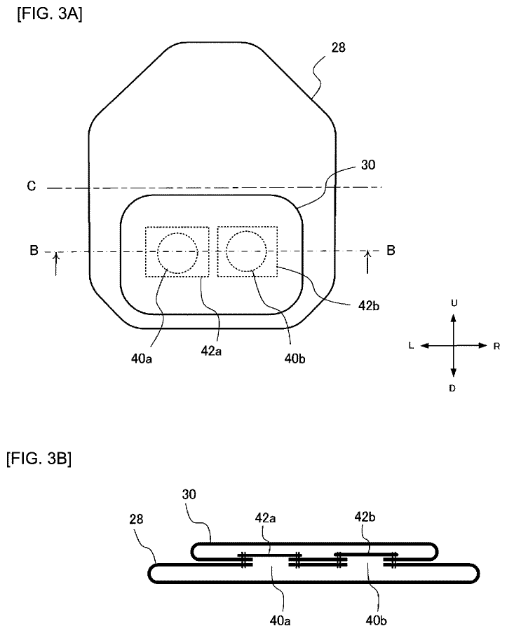

FIG. 1 is a side surface view depicting the inside of a vehicle provided with an airbag device according to the present invention. FIGS. 2(A) and 2(B) are side surface views depicting deployed states of front airbags according to Embodiment 1 of the present invention. FIG. 3(A) is a front surface view depicting a structure of the front airbags according to Embodiment 1 of the present invention. FIG. 3(B) is a cross-sectional view along B-B in FIG. 3(A);

As depicted in FIG. 1, the airbag device according to the embodiment of the present invention is for protecting the occupant P0 seated in a seat 11 in a vehicle cabin 10 of a vehicle, and includes: a front airbag unit 14 stowed in a roof portion 12; and a knee airbag unit 20 stowed in an instrument panel 18. The front airbag unit 14 includes an inflator 16 for generating expansion gas. Similarly, the knee airbag unit 20 includes an inflator 22 for generating expansion gas.

The front airbag unit 14 is installed on the inner side of the roof part 12, but can also be installed on the outer side of the roof part 12. Furthermore, the front airbag unit 14 can be disposed in a vicinity of a boundary between a windshield 24 and a roof lining 12, and can be installed, for example, on a back side of a sun visor (not depicted).

Front airbags 28, 30 are basically configured to deploy behind a monitor 26 installed on the instrument panel 18.

As depicted in FIGS. 2(A), 2(B), and 3, the front airbag unit 14 includes the front airbags 28, 30 that expand and deploy in front of the occupant P0 by expansion gas supplied from the inflator 16. The front airbags 28, 30 include: a first chamber 28 that deploys downward from the roof portion 12 of the vehicle; and a second chamber 30 that is connected to the front of the first chamber 28. Furthermore, expansion gas flows from the first chamber 28 into the second chamber 30.

As depicted in FIG. 2(A), the first chamber 28 and the second chamber 30 deploy behind the monitor 26 installed on the instrument panel 18, but as depicted in FIG. 2(B), the second chamber 30 can also deploy between the first chamber 28 and the windshield 24. In this case, a reaction force can be obtained from the windshield 24 when the second chamber 30 deploys. In order to obtain the deployment form of the second chamber 30 as depicted in FIG. 2(B), it is possible to devise a measure such as increasing the capacity of the second chamber 30, or the like. Furthermore, if the height of the monitor 26 is low or if the monitor 26 does not protrude above the instrument panel 18, the second chamber 30 may also deploy in the direction of the windshield 24.

An exhaust port 34 is formed on a side surface of a large-capacity first chamber 28, such that gas inside the first chamber 28 can be discharged to the outside. On the other hand, an exhaust port is not formed in the small-capacity second chamber 30. However, if necessary, an exhaust port of an appropriate size can be formed in the second chamber 30.

The knee airbag unit 20 includes a knee airbag 32 that expand and deploys toward a lower extremity of the occupant by expansion gas supplied from the inflator 22.

As depicted in FIG. 2, when the front airbags 28, 30 and the knee airbag 32 are fully deployed, a lower end part of the second chamber 30 and an upper end part of the knee airbag 32 come into contact with each other. In the drawings, reference numeral 36 denotes a connection point between the first chamber 28 and the second chamber 30, and reference numeral 38 denotes a contact point between the lower end part of the second chamber 30 and the upper end part of the knee airbag 32.

As depicted in FIG. 3, the capacity of the second chamber 30 is set to be smaller than the capacity of the first chamber 28. Furthermore, the second chamber 30 is connected to the first chamber 28 on a lower side from a center C in the up-down direction.

Two circular communication ports 40a, 40b are formed at the connection point 36 between the first chamber 28 and the second chamber 30, and outer circumferences of these communication ports 40a, 40b are connected by stitching. Furthermore, the communication ports 40a, 40b are provided with check valves 42a, 42b, and the expansion gas that has flowed into the second chamber 30 is prevented from flowing back into the first chamber 28. The check valves 42a, 42b open when the internal pressure of the first chamber 28 reaches a prescribed pressure.

The check valves 42a, 42b are flexible textile members arranged so as to cover the communication ports 40a, 40b and can be, for example, formed from the same fabric as a fabric forming an airbag. End parts of the check valves 42a, 42b are connected to an inner surface of the second chamber 30 by stitching.

The check valves 42a, 42b become convex toward the inside of the second chamber 30 due to gas flowing from the first chamber 28 into the second chamber 30, thereby opening the communication ports 40a, 40b and allowing gas to flow from the first chamber 28 into the second chamber 30. Thereafter, the check valves 42a, 42b are in a closed state by the gas pressure inside the second chamber 30, such that gas does not flow back into the first chamber 28. On the other hand, if the internal pressure of the first chamber 28 does not rise sufficiently, the check valves 42a, 42b maintain the communication ports 40a, 40b in a closed state.

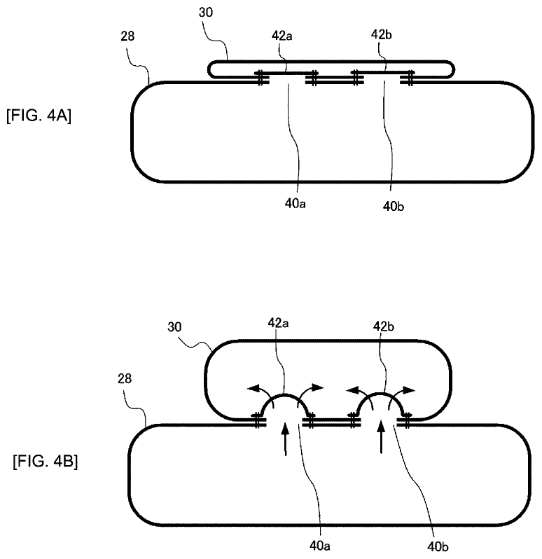

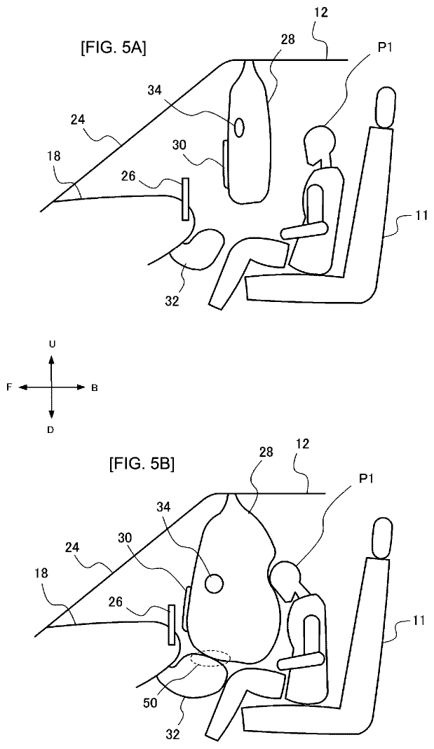

FIGS. 4(A) and 4(B) are cross-sectional views depicting a first deployed state (A) and a second deployed state (B), respectively, of the front airbags 28, 30 according to Embodiment 1 of the present invention, and correspond to the cross section along B-B in FIG. 3(A). FIGS. 5(A) and 5(B) are side surface views depicting deployed states of the airbags when the physique of the occupant P1 is small.

As depicted in FIG. 5(A), when a vehicle collision event occurs, the first chamber 28 of the front airbag 28, 30 begins to deploy downward on the front surface of the occupant P1.

Thereafter, as depicted in FIG. 5(B), when the occupant P1 enters the first chamber 28 in a state in which the first chamber 28 is almost fully deployed, the internal pressure of the first chamber 28 does not become very high due to the physique of the occupant P1 being small. Therefore, as depicted in FIG. 4(A), the check valves 42a, 42b do not open, the expansion gas does not flow from the first chamber 28 into the second chamber 30, and the front airbags 28, 30 as a whole are expanded to a small size. As a result, the occupant can be softly supported and protected.

Note that by the lower end of the first chamber 28 coming into contact with the upper end of the knee airbag 32, the first chamber 28 does not drop more than necessary, and the deployment shape and deployment posture of the first chamber 28 are stabilized.

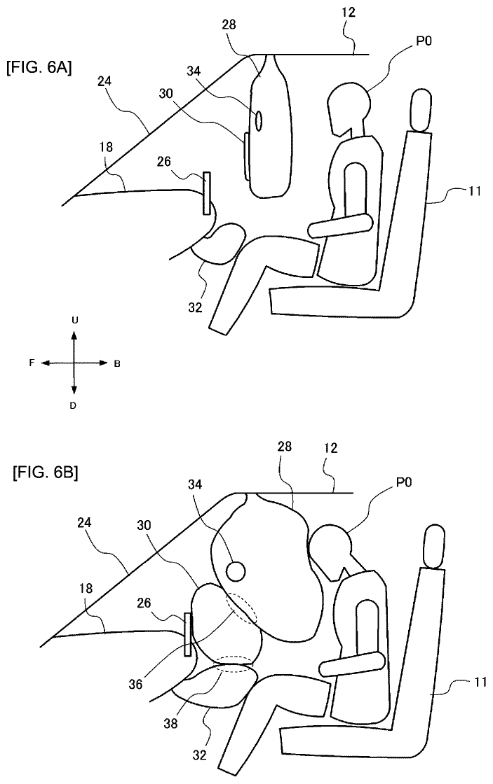

FIGS. 6(A) and 6(B) are side surface views depicting deployed states of the airbags when the physique of the occupant P0 is large.

As depicted in FIG. 6(A), when a vehicle collision event occurs, the first chamber 28 of the front airbag 28, 30 begins to first deploy downward on the front surface of the occupant P1.

Thereafter, as depicted in FIG. 6(B), when the occupant P1 enters the first chamber 28 in a state in which the first chamber 28 is almost fully deployed, the internal pressure of the first chamber 28 rises due to the physique of the occupant P1 being large. Therefore, as depicted in FIG. 4(B), the check valves 42a, 42b open, the expansion gas flows from the first chamber 28 into the second chamber 30, and as depicted in FIG. 6(B), the second chamber 30 also fully deploys. As a result, the stroke (impact absorption range) of the entire front airbags 28, 30 in the front-back direction is increased, and thus the movement of the occupant P0 in the front-back direction can be reliably restrained.

Note that by the lower end of the second chamber 30 coming into contact with the upper end of the knee airbag 32, bottom parts of the front airbags 28, 30 are supported, and the deployment shape and deployment posture of the front airbags 28, 30 are stabilized.

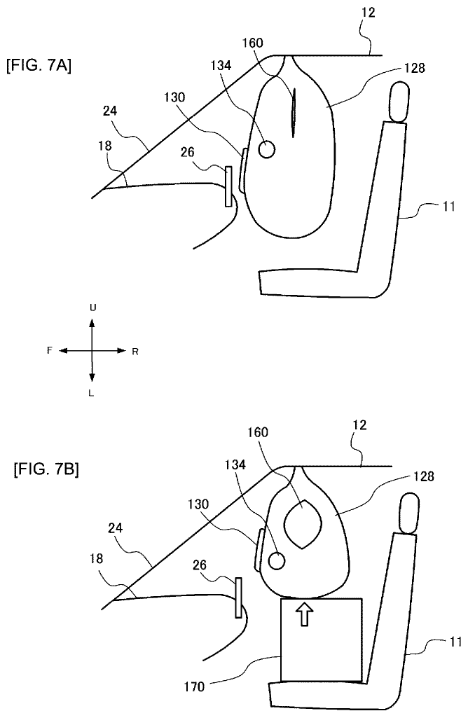

FIG. 7(A) and 7(B) are side surface views depicting deployed states of airbags according to Embodiment 2 of the present invention. Components that are the same as or correspond to those in Embodiment 1 described above are provided with the same reference numerals, and redundant descriptions thereof are omitted. Note that FIG. 7(A) depicts a state in which an occupant is not seated in the seat 11, and FIG. 7(B) depicts a state in which an obstacle 170 is placed on a seat surface of the seat 11. Note that the situation depicted in FIG. 7(B) can be considered to be equivalent to a situation in which a small child is seated or lying down. Furthermore, for convenience of explanation, a knee airbag is not depicted, but in actuality, a knee airbag may be provided.

In the present embodiment, as depicted in FIG. 7(A), a slit 160 is formed in addition to an exhaust port 134 on a side surface of a first chamber 128. Other configurations are basically the same as those of Embodiment 1 described above. The slit 160 extends in the up-down direction and can be a simple narrow cut, or can be slot-shaped having a certain width.

As depicted in FIG. 7(A), when a vehicle collision event occurs with no occupant seated in the seat 11, the first chamber 128 of the front airbag begins to deploy downward from the roof portion 12 behind the monitor 26. Even when the first chamber 128 is almost fully deployed, the internal pressure of the first chamber 128 does not increase due to the absence of an occupant. Thus, as depicted in FIG. 4(A), the check valves 42a, 42b do not open, expansion gas does not flow from the first chamber 128 into the second chamber 130, and the second chamber 130 does not deploy.

On the other hand, as depicted in FIG. 7(B), when a vehicle collision event occurs with the obstacle 170 placed on the seat surface of the seat 11, the first chamber 128 of the front airbag begins to deploy downward from the roof portion 12 behind the monitor 26. A lower end of the first chamber 128 comes into contact with the obstacle 170, preventing downward deployment of the first chamber 128 and causing the first chamber 128 to become wider in a horizontal direction and the slit 160 to open widely in the front-back direction (horizontal direction). Therefore, the internal pressure of the first chamber 128 does not increase. Thus, as depicted in FIG. 4(A), the check valves 42a, 42b do not open, expansion gas does not flow from the first chamber 128 into the second chamber 130, and the second chamber 130 does not deploy. Furthermore, pressure on the obstacle 170 present on the seat 11 does not excessively increase, and the possibility of the obstacle 170 being damaged can be reduced.

### Interpretation of the Technical Scope of the Present Invention

Embodiments of the present invention have been described above. However, the present invention is not limited in any way to the embodiments described above and can be changed as appropriate within the scope of the technical idea as defined in the patent claims.

1. An airbag device for protecting an occupant in a cabin of a vehicle, the airbag device comprising:
a front airbag that expands and deploys in front of an occupant seated in a seat; and
an inflator that supplies expansion gas to the front airbag, wherein
the front airbag includes a first chamber that deploys downward from a roof portion of the vehicle and a second chamber that deploys in front of the first chamber.

2. The airbag device according to claim 1, wherein the second chamber is connected to the front of the first chamber.

3. The airbag device according to claim 2, wherein a communication port through which gas flows is provided at a connecting portion between the first chamber and the second chamber, and
the expansion gas flows from the first chamber into the second chamber through the communication port.

4. The airbag device according to claim 3, wherein the communication port is provided with a check valve, and
the expansion gas that has flowed into the second chamber is prevented from flowing back into the first chamber.

5. The airbag device according to claim 4, wherein the check valve closes when the internal pressure of the second chamber reaches or exceeds a prescribed pressure.

6. The airbag device according to claim 2, wherein the second chamber is connected to the first chamber below a center in an up-down direction.

7. The airbag device according to claim 1, wherein the first chamber deploys behind an instrument panel.

8. The airbag device according to claim 7, wherein the second chamber expands and deploys between the first chamber and the instrument panel.

9. The airbag device according to claim 1, wherein the capacity of the first chamber is larger than the capacity of the second chamber.

10. The airbag device according to claim 1, wherein the front airbag includes a knee airbag that deploys from a lower part of an instrument panel toward a lower extremity of an occupant, and
a lower end of at least one of the first chamber and the second chamber is in contact with an upper end of the knee airbag.

11. The airbag device according to claim 1, wherein a first exhaust port for exhausting the expansion gas is formed in the first chamber.

12. The airbag device according to claim 11, wherein an exhaust port for exhausting the expansion gas is not formed in the second chamber.

13. The airbag device according to claim 11, wherein a slit-shaped or slot-shaped vent opening extending in the up-down direction is formed in the first chamber, and
the vent opening opens widely when the lower end of the first chamber is subjected to pressure by some obstacle.

14. The airbag device according to claim 1, wherein the first chamber is deployed downward from a vicinity of a boundary between a roof and a windshield of the vehicle.

15. The airbag device according to claim 1, wherein the second chamber expands and deploys between the first chamber and the windshield.
